(19) United States
(12) Patent Application Publication
(10) Pub. No.: US 2025/0328480 A1
(43) Pub. Date: Oct. 23, 2025

(54) METHODS FOR BATTERY MANAGEMENT SYSTEM (BMS) ADDRESS ALLOCATION IN UNINTERRUPTIBLE POWER SUPPLY (UPS) SYSTEMS AND UPS SYSTEMS BASED ON THE METHODS

(71) Applicant: Lian Zheng Electronics (Shenzhen) Co., Ltd., Shenzhen City (CN)

(72) Inventors: Zicheng Feng, Shenzhen (CN); Liang Rao, Shenzhen (CN); Hu Qin, Shenzhen (CN); Yinzhuo Chen, Shenzhen (CN)

(21) Appl. No.: 19/186,093

(22) Filed: Apr. 22, 2025

(30) Foreign Application Priority Data
Apr. 23, 2024 (CN) 202410490085.X

(51) Int. Cl. G06F 13/20; H01M 10/42

(52) U.S. Cl. CPC G06F 13/20; G06F 2213/0052; H01M 10/425; H01M 2010/4271

(57) ABSTRACT

Methods for BMS address allocation in a UPS system are provided. The method includes: S1: broadcasting an address allocation start instruction; S2: setting its output port to a second preset level and its address allocation flag as “uncompleted”, and setting, by the built-in BMS, its address allocation flag to “uncompleted”; S3: broadcasting, by the UPS, an address allocation instruction; S4: performing, by a BMS whose input port is at the first preset level and whose address allocation flag is uncompleted, address setting, and after the address setting is completed, setting its address allocation flag as “completed” and replying address information to the UPS; S5: receiving, by the UPS, the replied address information, and sending a port configuration instruction to the BMS, so that the BMS sets its output port to the first preset level; and S6: repeating steps S3 to S5 until all BMSs have completed address allocation.

### CROSS-REFERENCE TO RELATED APPLICATION

This application claims priority to Chinese Patent Application No. 202410490085.X, filed Apr. 23, 2024, the content of which is incorporated herein by reference in its entirety.

### TECHNICAL FIELD

The present inventive concept relates to the field of uninterruptible power supplies (UPS), particularly to address allocation for battery management systems (BMSs) in an uninterruptible power supply, and more particularly to methods for BMS address allocation in a scalable UPS systems and UPS systems based on the method.

### BACKGROUND

An online uninterruptible power supply can continuously supply power to a load and has been widely used in various fields. As shown in FIG. 1, the current common UPS system is internally configured with a battery management system (BMS) module (which can be abbreviated as BMS), and can be externally configured with a plurality of BMSs. The UPS may collect battery-related information, and monitor and manage batteries through these BMSs. Generally, the UPS system communicates with the BMS modules based on an RS485 bus. Each of the BMSs needs to be allocated a fixed address so that the UPS system can specify a certain BMS to reply information through its allocated address. In conventional technology, a common address allocation manner is a chip selection manner. Each BMS needs to use one port pin of a UPS to implement fixed address allocation. The quantity of required port pins on the UPS corresponds directly to the quantity of BMSs. As the quantity of BMSs increases, the quantity of occupied port pins of the UPS also increases. Each time the quantity of BMSs needs to be expanded, the quantity of port pins of the UPS needs to be increased accordingly. Such a manner is extremely inconvenient and has limited scalability. In addition, for older UPSs, there is no redundant port pin for extension use, and the chip selection manner also limits the conversion of a lead-acid UPS to a lithium-ion UPS.

It should be noted that this background is merely used to describe related information of the present inventive concept, to help understand the technical solutions of the present inventive concept, but does not mean that the related information is necessarily the prior art. In the absence of evidence that the related information has been disclosed before the application date of the present inventive concept, the related information shall not be considered as the prior art.

### SUMMARY

Therefore, some embodiments of the present inventive concept provide a convenient and flexible solution for BMS address allocation in UPS systems, to support more convenient BMS expansion and UPS conversion.

According to some embodiments of the present inventive concept, a method for BMS address allocation in a UPS system is provided. The UPS system includes a UPS, a first built-in BMS, and a plurality of external BMSs, each of the external BMSs being configured with an input port and an output port, and the first built-in BMS being configured with an input port. The plurality of external BMSs are serially connected, an output port of a previous external BMS is connected to an input port of a next external BMS, the input port of the first built-in BMS is connected to an output port of the last external BMS, and an input port of a first external BMS is set to a first preset level. The method includes: S1: broadcasting, by the UPS, an address allocation start instruction; S2: setting, by each of the external BMSs, its output port to a second preset level and its address allocation flag as “uncompleted” according to the address allocation start instruction, and setting, by the first built-in BMS, its address allocation flag as “uncompleted” according to the address allocation start instruction; S3: broadcasting, by the UPS, an address allocation instruction; S4: performing, by a BMS of which an input port is at the first preset level and an address allocation flag is “uncompleted”, address setting according to the address allocation instruction, and after the address setting is completed, setting its address allocation flag as “completed” and replying address information to the UPS; S5: receiving, by the UPS, the address information replied by the BMS that has completed the address setting, and sending a port configuration instruction to the BMS according to the address information, so that the BMS sets its output port to the first preset level; and S6: repeating steps S3 to S5 until all BMSs have completed address allocation.

In some embodiments of the present inventive concept, the first preset level is a low level, the second preset level is a high level, or the first preset level is a high level, and the second preset level is a low level.

In some embodiments, all the BMSs have completed address allocation specifically is: if the UPS continuously broadcasts an address allocation instruction for a preset quantity of times, and does not receive the address information replied by any BMS, determining that all the BMSs have completed address allocation.

In some embodiments, the UPS broadcasts an address allocation end instruction after determining that all the BMSs have completed address allocation.

In some embodiments of the present inventive concept, the UPS system further includes a second built-in BMS, an input port of the second built-in BMS being connected to an output terminal of the UPS. The method further includes: broadcasting, by the UPS, the address allocation start instruction, and setting the output terminal of the UPS to the second preset level. After all the BMSs have completed address allocation, the method further includes: setting, by the UPS, the output terminal of the UPS to the first preset level and broadcasting an address allocation instruction; and performing, by the second built-in BMS, address setting according to the address allocation instruction, and after the address setting is completed, replying, by the second built-in BMS, address information to the UPS.

In some embodiments, the method further includes: after receiving the address information replied by the second built-in BMS, setting, by the UPS, the output terminal of the UPS to the second preset level, and broadcasting, by the UPS, an address allocation end instruction.

In some embodiments, after the broadcasting, by the UPS, an address allocation end instruction, each of the external BMSs sets its output port to the second preset level according to the address allocation end instruction.

In some embodiments, the method further includes: after the broadcasting, by the UPS, an address allocation end instruction, determining, by the UPS, whether a total quantity of BSs that have completed address allocation is equal to a preset total quantity of BMSs, and if the total quantity of BMSs that have completed address allocation is not equal to the preset total quantity of BMSs, giving an alarm.

In further embodiments of the present inventive concept, a method for BMS address allocation in a UPS system is provided. The UPS system includes a UPS, one built-in BMS, and one external BMS, the external BMS being configured with an input port and an output port, and the built-in BMS being configured with an input port. The output port of the external BMS is connected to the input port of the built-in BMS, and the input port of the external BMS is set to a first preset level. The method includes: broadcasting, by the UPS, an address allocation start instruction; after receiving the address allocation start instruction, setting, by the external BMS, its output port to a second preset level and its address allocation flag as “uncompleted”, and setting, by the built-in BMS, its address allocation flag as “uncompleted” according to the address allocation start instruction; broadcasting, by the UPS, an address allocation instruction; performing, by the external BMS, address setting according to the address allocation instruction, and after the address setting is completed, setting, by the external BMS, the address allocation flag to completed and replying address information to the UPS; sending, by the UPS, a port configuration instruction to the external BMS based on the received information replied by the external BMS, so that the external BMS sets its output port to the first preset level; broadcasting, by the UPS, the address allocation instruction again; and performing, by the built-in BMS, address setting.

In still further embodiments of the present inventive concept, a UPS system is provided. The UPS system includes a UPS, one built-in BMS, and a plurality of external BMSs, and is configured to perform BMS address allocation by using the method according to the first aspect, or the UPS system includes a UPS, two built-in BMSs, and a plurality of external BMSs, and is configured to perform BMS address allocation by using the method according to the first aspect, or the UPS system includes a UPS, one built-in BMS, and one external BMS, and is configured to perform BMS address allocation by using the method according to the second aspect.

Compared with the conventional technology, the present inventive concept has the following advantages: An address allocation solution in the present application is completely not limited by hardware of chip select pins of a UPS, a quantity of BMSs can be flexibly expanded, and during each expansion, expanded BMSs communicate with the UPS through an RS485 and are serially connected between an existing external BMS and a built-in BMS or to the outermost external BMS, and then address reallocation can be performed on the entire BMS system. In the solution of the present inventive concept, address allocation can be implemented by flexibly setting an input port and an output port of each BMS, without adding any chip select pin of the UPS, thereby facilitating flexible modular expansion of the BMS. In addition, a bus communication manner is used in the present inventive concept, which is applicable to a lead-acid battery or a lithium battery, so that the lead-acid battery can adapt to the UPS system described in the present inventive concept as long as it has an RS485 communication function, thereby implementing the conversion.

### BRIEF DESCRIPTION OF THE DRAWINGS

The following further describes some embodiments of the present inventive concept with reference to the accompanying drawings, where:

FIG. 1 is a schematic diagram of a structure of a UPS system using a chip selection manner.

FIG. 2 is a schematic diagram of a structure of a UPS system including one built-in BMS and a plurality of external BMSs according to some embodiments of the present inventive concept.

FIG. 3 is a schematic diagram of a structure of a UPS system including one built-in BMS and three external BMSs according to some embodiments of the present inventive concept.

FIG. 4 is a schematic flowchart of a method for address allocation of one built-in BMS and a plurality of external BMSs according to some embodiments of the present inventive concept.

FIG. 5 is a schematic diagram of a structure of a UPS system including two built-in BMS and a plurality of external BMSs according to some embodiments of the present inventive concept.

FIG. 6 is a schematic flowchart of method for address allocation for two built-in BMSs and a plurality of external BMSs according to some embodiments of the present inventive concept.

FIG. 7 is a schematic diagram of a structure of a UPS system including one built-in BMS and one external BMS according to some embodiments of the present inventive concept.

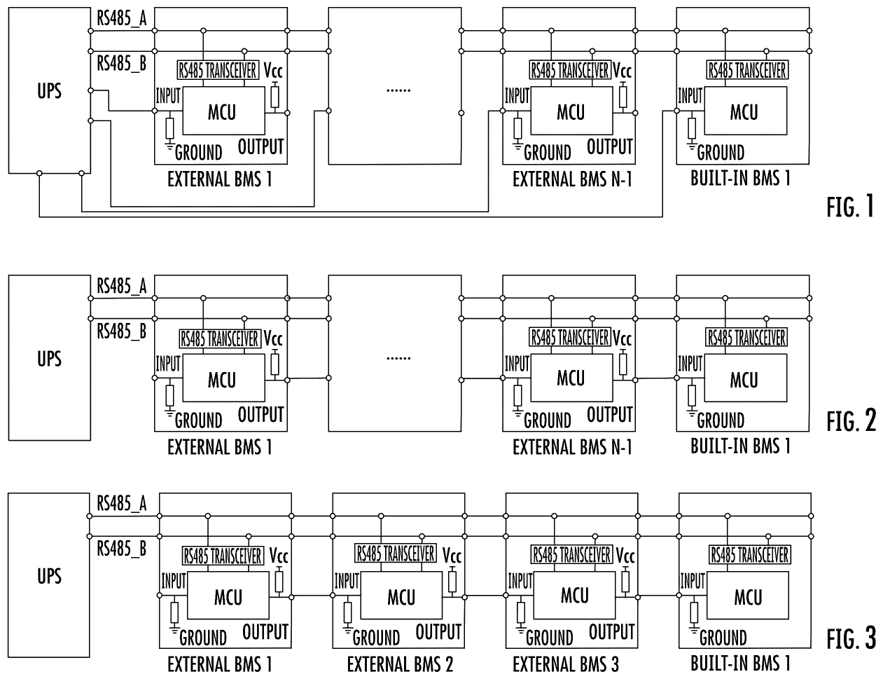

### DETAILED DESCRIPTION

To make the objectives, technical solutions, and advantages of the present inventive concept clearer, the following further describes the present inventive concept in detail through specific embodiments with reference to the accompanying drawings. It should be understood that the specific embodiments described herein are merely intended to explain the present inventive concept, and are not intended to limit the present inventive concept.

As mentioned in the background, an address allocation solution in the chip selection manner for a UPS system in conventional technology limits the expansion of a UPS and the conversion of a UPS from a lead-acid battery to a lithium battery. Therefore, the present inventive concept proposes a new method for address allocation in a UPS system, to support more flexible BMS expansion and conversion of the UPS system.

Before the embodiments of the present inventive concept are specifically described, some terms used therein are first explained as follows:

UPS: uninterruptible power supply, which is an uninterruptible power supply including an energy storage device. The UPS is mainly used to provide an uninterrupted power supply for some devices with high power supply stability requirements. The UPS can be powered by a built-in battery and an external battery. The built-in battery is a battery pre-installed in a UPS body and usually has a relatively small capacity. The external battery may be connected to an extended battery pack of the UPS through a connector. Therefore, a battery pack with a larger capacity may be selected according to a requirement. The built-in battery supplies power for a short time, which usually can only last several minutes to dozens of minutes. However, the external battery may supply power for a longer time, and the power supply time may be further prolonged by increasing the quantity of battery packs. The built-in battery is usually fixedly installed inside the UPS body and is difficult to replace or upgrade. However, the external battery can be replaced, upgraded, or increased relatively easily. The batteries herein may be lead-acid batteries or lithium batteries.

BMS: battery management system, which is configured to monitor the status of a battery, control the charging and discharging of the battery, and the like. Each battery of a UPS system is equipped with a BMS module associated with the battery. A UPS collects battery-related information through the BMS associated with each battery and monitors and manages these batteries. It should be noted that, generally, there is no controller in a lead-acid battery, and functions such as a charging and discharging control function and a power estimation function of the lead-acid battery are completed through the UPS, and the lithium battery has an independent controller, namely, a BMS, and is self-managed by itself.

RS485: also referred to as RS-485 or EIA-485, which is under a standard that specifies electrical characteristics of a physical layer of an OSI model as a 2-wire, half-duplex, and balanced transmission line for multi-point communication. A system using RS485 communication can have a plurality of receivers on one network under a configuration of a linear multi-point bus, so that the system is applicable to an industrial environment. In the UPS system, a control chip of the UPS is usually utilized to communicate with the BMS module of each battery based on an RS485 bus.

Port: an input/output pin, which includes a port device and a port interface, and mainly refers to an interface in the present inventive concept.

To better understand the present inventive concept, the following describes the present inventive concept in detail from various embodiments with reference to the accompanying drawings and embodiments. The present inventive concept mainly describes cases including one built-in BMS and a plurality of external BMSs, two built-in BMSs and a plurality of external BMSs, as well as one built-in and one external BMS.

### I. One Built-In BMS and a Plurality of External BMSs

According to a UPS system in some embodiments of the present inventive concept, the UPS system includes a UPS, one built-in BMS (for ease of distinction, when there is one built-in BMS, it is directly referred to as a built-in BMS; and when there are two built-in BMSs in subsequent embodiments, the two built-in BMSs are referred to as a built-in BMS1, a built-in BMS2, respectively), and a plurality of external BMSs. FIG. 2 shows a UPS system including one built-in BMS and N-1 external BMSs. A control logic or a control chip of a UPS (because the control logic and the control chip of the UPS are technologies known to a person skilled in the art, the two are not shown in all the accompanying drawings of the embodiments of the present inventive concept, but do not affect understanding of the present inventive concept, and the accompanying drawings of the embodiments of the present inventive concept focus on demonstrating the connection and communication between BMSs and the UPS) may communicate with each BMS by using an RS485 bus. It can be learned from FIG. 2 that the UPS is connected to all BMSs through two transmission lines RS485_A and RS485_B. It should be noted herein that communication between the UPS and BMS is not limited to RS485, and other bus communication such as CAN communication may be performed. RS485 is used as an example for description in these embodiments of the present inventive concept, and other communication modes are similar to RS485 and are not described in detail again. Each BMS has an RS485 transceiver which is connected to two RS485 buses, to receive and transmit information. The external BMS is configured with an input port and an output port for address allocation, and the built-in BMS is configured with only an input port for address allocation. Each BMS further includes one microprocessor control unit (MCU). The MCU is configured to implement control and configuration functions of the BMS, for example, configure the input port and the output port of the BMS. For a person skilled in the art, functions of the MCU of the BMS are known, and details are not described herein. The input ports and output ports for addressing are serially connected for all the BMSs. An output port of a previous BMS is connected to an input port of a next BMS. Because the built-in BMS has only an input port, the built-in BMS is used as a last BMS in these embodiments of the present inventive concept. The input port of the first BMS is set to a first preset level (for example, a low level). Each BMS is configured with an address allocation flag, which is used to indicate whether the corresponding BMS have completed address allocation.

When the UPS system shown in FIG. 2 performs address allocation, the UPS broadcasts an address allocation start instruction. After receiving the address allocation start instruction, each BMS sets its output port to a second preset level (for example, a high level), and set its corresponding address allocation flag as “uncompleted,” and the built-in BMS sets its address allocation flag as “uncompleted” according to the address allocation start instruction. After sending the address allocation start instruction, the UPS broadcasts address allocation instructions for a plurality of times (the address allocation instruction carries an address to be allocated), and each address allocation instruction carries one address to be allocated until all the BMSs have completed address allocation. All the BMSs have completed address allocation means that if the UPS continuously broadcasts the address allocation instruction for a preset quantity of times, and does not receive the address information replied by any BMS, it is determined that all the BMSs have completed the address allocation. Each time the UPS broadcasts an address allocation instruction, the BMS whose input port is at the first preset level and whose address allocation flag is “uncompleted” performs address setting according to the address allocation instruction, and after the address setting is completed, sets the address allocation flag as “completed” and replies address information to the UPS to notify the UPS. The UPS receives the address information replied by the BMS that have completed the address allocation, and sends a port configuration instruction to the BMS according to the address information, so that the BMS sets its output port to the first preset level (for example, a low level), while the BMS to which no address is allocated, the BMS to which an different address has been allocated and the built-in BMS do not respond to this UPS instruction. In the foregoing solution, instead of using and extending the chip select pin of the UPS, the address allocation can be implemented directly through the input and output pins of the BMS, which facilitates the expansion of BMSs.

It should be understood that the first preset level and the second preset level are two different levels, for example, a high level and a low level. However, which one of the first level and the second level is a low level and which one is a high level are not limited, provided that the two are different levels. However, for ease of description, in the subsequent embodiments, an example in which the first preset level is a low level and the second preset level is a high level is used for description. In addition, in the UPS system, the UPS communicates with each BMS through the control logic or the control chip of the UPS by using an RS485 bus, including broadcasting various instructions and collecting the status of batteries and the like. Because an operating principle of the control logic in the UPS system is a technology known to a person skilled in the art, the control logic is not described in detail in the present inventive concept. In the embodiments, the UPS is used as a body for description. However, it should be understood that the UPS implements these functions through the control logic or the control chip of the UPS.

Still referring to FIG. 2, the external BMS has an input port (at a low level by default) for address allocation and an output port (at a high level by default) for address allocation, and the built-in BMS has only one input port (at a low level by default) for address allocation. The input port is at a low level by default when grounded, and the output port is at a high level by default when connected to a Vcc. Because all the BMSs are serially connected, when a previous BMS starts to perform address allocation, the output port of the BMS is set to a high level. Then, the input port of a next BMS connected in series with the previous BMS is also set to a high level, so that the next BMS does not participate in the address allocation. After the previous BMS have completed address allocation, the output port of the previous BMS is set to a low level, and the input port of the next BMS connected in series with the previous BMS is correspondingly set to a low level. Therefore, when the UPS broadcasts an address allocation instruction next time, the next BMS is a BMS whose input port is at the first preset level (a low level) and whose address allocation flag is set as “uncompleted,” and can perform the address allocation. In this way, the BMSs that are serially connected may perform address allocation in sequence without colliding, which is more conducive to expansion.

According to some embodiments of the present inventive concept, after broadcasting an address allocation instruction, if the U PS does not receive address information replied by any BMS, the UPS repeatedly broadcasts the address allocation instruction having no replied address information for a plurality of times until the address allocation instruction is continuously broadcast for a preset quantity of times. If the UPS still does not receive address information replied by any BMS, the UPS broadcasts an address allocation end instruction. For example, if the preset quantity of times is set to three, that is, if no replied address information is received after the address allocation instruction is continuously broadcast three times, it is determined that address allocation has been completed for each BMS, and the process of address allocation may be ended. In some embodiments of the present inventive concept, each external BMS sets its output port to a high level when receiving the address allocation end instruction.

According to an example of the present inventive concept, FIG. 3 shows a UPS system including four BMSs. In the UPS system, one built-in BMS and three external BMSs (external BMS1, external BMS2, and external BMS3) are used. Input and output ports of the external BMS1, the external BMS2, the external BMS3, and the built-in BMS are serially connected. The input port of the external BMS1 is set to a low level, and an address allocation flag of each BMS is set as “uncompleted”. A UPS broadcasts an address allocation start instruction. After receiving the address allocation start instruction, each BMS sets the output port to a high level and sets the address allocation flag as “uncompleted.” In this case, the output ports of all the BMSs are at a high level, and the input ports of the external BMS2, the external BMS3, and the built-in BMS are also at a high level. Then, only the external BMS1 is a BMS of which the input port is at a low level and the address allocation flag is “uncompleted”. After broadcasting the address allocation start instruction, the UPS starts to broadcast an address allocation instruction. After receiving the address allocation instruction, the external BMS1 sets its address as the address carried in the address allocation instruction, sets the address allocation flag as “completed”, and then replies address information to the UPS to notify the UPS of the set address information of the external BMS1. After receiving the address information replied by the external BMS1, the UPS sends a port configuration instruction with the address information of the external BMS1 to the external BMS1. After receiving the port configuration instruction, the external BMS1 sets its output port to a low level. The other BMSs do not respond because their addresses are different from the specified address by the UPS or no addresses are allocated to the other BMSs. After the address setting of the external BMS1 is completed, the output port of the external BMS1 is set to a low level. In this case, the input port of the external BMS2 connected to the external BMS1 is also changed to a low level. Because the output port of the external BMS2 is still at a high level, the input ports of the external BMS3 and the built-in BMS that are serially connected to after the external BMS2 are at a high level. In this way, when the UPS broadcasts a next address allocation instruction, which is similar to the process of the external BMS1, only the external BMS2 meets a condition that the input port is at a low level and the address allocation flag is “uncompleted”. Therefore, the address allocation of the external BMS2 starts to be performed. By analogy, address allocation for the external BMS3 and the built-in BMS can be completed. After the built-in BMS completes address allocation, the UPS broadcasts an address allocation instruction again, and cannot receive replied address information. After the UPS repeatedly broadcasts the address allocation instruction carrying an addresses to be allocated for a plurality of times, if the UPS receives no replied address information, the address allocation may be ended and the UPS broadcasts an address allocation end instruction. After receiving the address allocation end instruction, each external BMS sets its output port to a high level.

In some other embodiments of the present inventive concept, to ensure that address allocation is correct, after broadcasting the address allocation end instruction, the UPS may determine whether a total quantity of BMSs that have completed address allocation is equal to a total quantity of BMSs set by the UPS. If the total quantity of BMSs that have completed address allocation is not equal to the total quantity of BMSs set by the UPS, the UPS gives an alarm, thereby improving the robustness of address allocation.

It can be learned from the foregoing embodiments that the address allocation solution in the present application is completely not limited by hardware of the chip select pins of a UPS, a quantity of BMSs can be flexibly expanded, and during each expansion, expanded BMSs communicate with the UPS through an RS485 and are serially connected between an existing external BMS and a built-in BMS or to the outermost external BMS, and then address allocation is performed according to the foregoing solution.

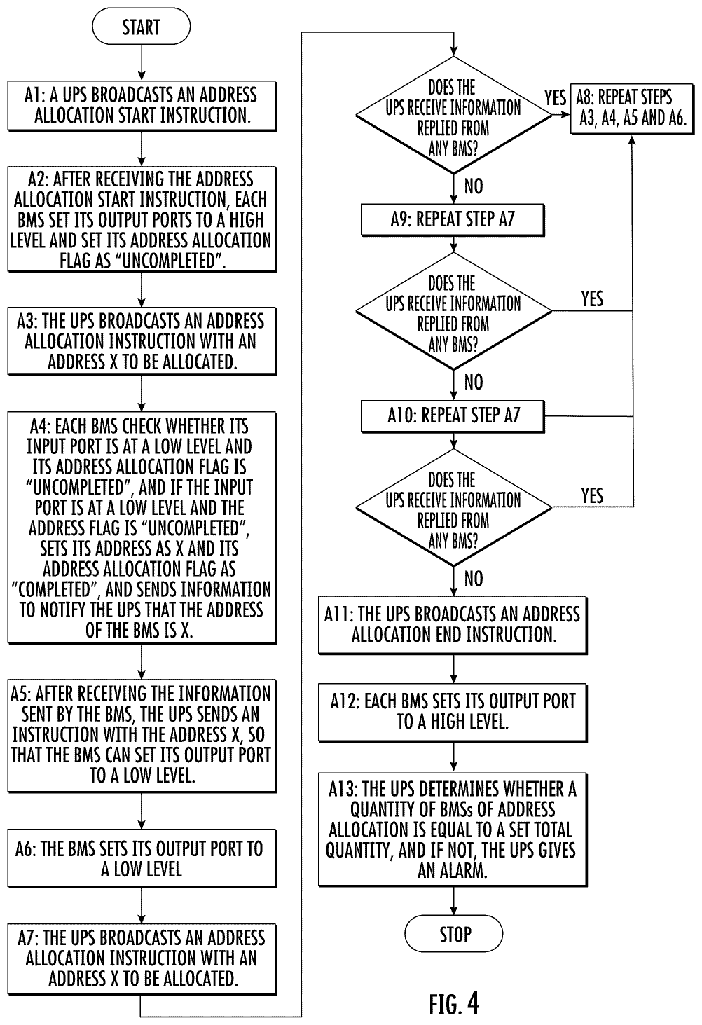

To understand the solution of the present inventive concept more clearly, the following describes in detail a process of address allocation in a UPS system that includes one built-in BMS and a plurality of external BMSs with reference to a flowchart provided in FIG. 4, and the process mainly includes the following steps:

Step A1: A UPS broadcasts an address allocation start instruction.

Step A2: After receiving the address allocation start instruction, each of all BMSs sets its output port to a high level and set its address allocation flag as “uncompleted”.

Step A3: The UPS broadcasts an address allocation instruction, where the address allocation instruction carries a to-be-allocated address x (x is used to generally indicate an address to be allocated, and does not indicate that an address can only be x), that is, after the address allocation start instruction is sent, the UPS broadcasts one address allocation instruction, and the instruction includes an address x to be allocated to a BMS.

Step A4: each of all the BMSs checks whether it input port is at a low level and its address allocation flag is set as “uncompleted”. if one of the BMSs has the input port at a low level and the address flag as “uncompleted,” the BMS sets its addresses as the address x and set its address allocation flag as “completed,” and sends information to notify the UPS that the address of the BMS is the address x. In short, after the UPS broadcasts the address allocation instruction with the addresses x to be allocated, each BMS receives the instruction and the address x carried in the instruction. The BMS whose input port is at a low level and whose address allocation flag is equal to “unallocated” sets its address as the address x (the BMS is referred to as BMS_x), sets its address allocation flag as “completed,” and sends an instruction to notify the UPS that the address of the BMS is x. When address allocation is performed for the first time, only the input port of the first BMS is not pulled high and is at a low level. Therefore, only the input port of the first BMS is at a low level and the address allocation flag is “uncompleted.” In subsequent allocation, although input ports of a plurality of BMSs may be at a low level, there is only one BMS of which the input port is at a low level and the address allocation flag is “uncompleted.” Therefore, no address conflict occurs.

Step A5: After receiving the information sent from the BMS_x, the UPS sends a port configuration instruction with the address x to instruct that the BMS_x sets its output port to a low level, while the external BMS with a different address, the external BMS to which an address is not allocated, and the built-in BMS do not respond.

Step A6: After receiving the port configuration instruction with the address x, the BMS_x sets its output port to a low level. After the address configuration of one BMS is completed, the output port of the BMS is set to a low level, and thus the input port of a next BMS serially connected to this BMS can be pulled down at the same time, so that the next BMS can participate in the next address configuration.

Step A7: The UPS broadcasts an address allocation instruction again, where the address allocation instruction carries an address x to be allocated, and determines whether any corresponding replied information is received. If the UPS receives the replied information, step A8 is performed. If the UPS does not receive the replied information, step A9 is performed.

Step A8: Repeat the steps A3, A4, A5, and A6.

Step A9: The UPS broadcasts to send the address allocation instruction with the address x to be allocated again, and determines whether the replied information is received. If the UPS receives the replied information, step A8 is performed. If the UPS does not receive the replied information, step A10 is performed.

Step A10: The UPS broadcasts the address allocation instruction with the address x to be allocated again and determines whether the replied information is received. If the UPS receives the replied information, step A8 is performed. If the UPS does not receive the replied information, step A11 is performed. Steps A3 to A6 are repeated until the UPS no longer receives information replied or fed back by the BMSs, and then the UPS tries three times through steps A7, A9, and A10. If no reply is received for three continuous times, it indicates that each BMS has completed address allocation and the process of address allocation can be ended.

Step A11: The UPS broadcasts an address allocation end instruction.

Step A12: After receiving the address allocation end instruction, each of all the BMSs sets its output port to a high level.

Step A13: The UPS determines the quantity of BMSs of address allocation with a set total quantity, and if the quantity of BMSs of address allocation is not equal to the set total quantity, the UPS gives an alarm. Herein, the quantity of BMSs of address allocation refers to the quantity of BMSs that have replied address information and completed address allocation. The set total quantity refers to the quantity of BMSs linked to the UPS system before address allocation is performed. A purpose of the comparison is to ensure that all the linked BMSs have completed the address allocation. If the address allocation is not completed, an alarm is given for remediation.

In addition, it should be noted that a lead-acid battery generally does not have a communication function, and therefore does not need address allocation. A corresponding pure lead-acid battery UPS generally does not have a BMS chip select pin function. Therefore, the lead-acid battery cannot adapt to a lithium battery UPS system using a chip selection manner, and application of the lead-acid battery is greatly limited. On the basis of the present inventive concept, the lead-acid battery only needs to be configured with an RS485 communication function and a charging function, thus can be adapted to a UPS system that performs communication based on the RS485, so as to implement the conversion, thereby improving application of the lead-acid battery.

### II. Two Built-In BMSs and a Plurality of External BMSs

The foregoing embodiments describes a process of address allocation in the UPS system including one built-in BMS and a plurality of external BMSs. The address allocation of a UPS system including two built-in BMSs and one or more external BMSs is similar to that of the UPS system including one built-in BMS and a plurality of external BMSs. The difference is that since the built-in BMS does not have an output port, when there are two built-in BMSs, the two built-in BMSs are connected in series at the last two locations, the input port of one built-in BMS is connected to an output port of an external BMS, and the input port of the other BMS is connected to an output terminal of the UPS. In addition, for the system including two built-in BMSs, only when the external BMSs and one built-in BMS of which the input port is connected to an output port of the external BMS complete address allocation, an addressing process of the remaining built-in BMS is performed. For the remaining built-in BMS, no output port of an external BMS is connected to the input port of the remaining built-in BMS, it is necessary to connect the output port of the UPS to the input port of the remaining built-in BMS to complete the addressing process. The following describes in detail the UPS system including two built-in BMSs and one or more external BMSs with reference to the accompanying drawings and embodiments.

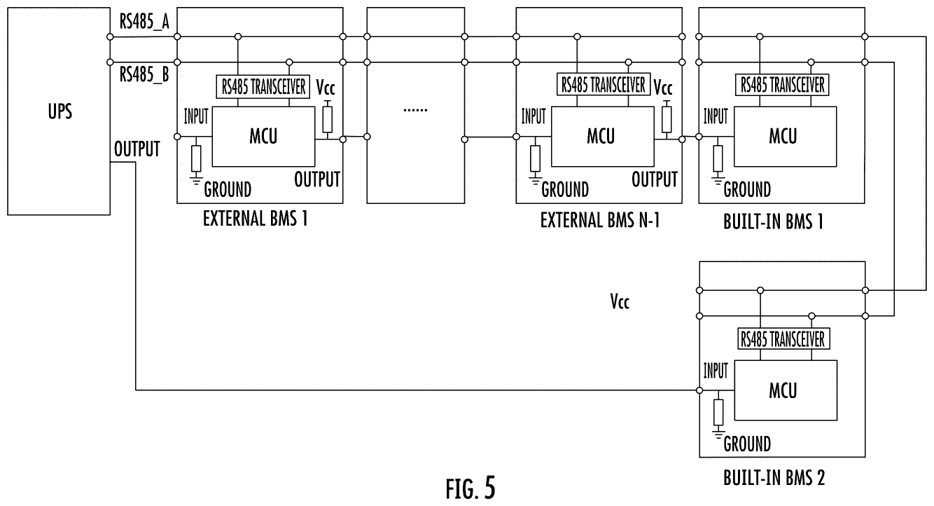

According to some embodiments of the present inventive concept, FIG. 5 shows a UPS system that includes two built-in BMSs and a plurality of external BMSs according to embodiments of this application. As shown in FIG. 5, in this case, the UPS system includes one UPS, two built-in BMSs, and a plurality of external BMSs. A control logic or a control chip of the UPS communicates with each BMS by using the RS485 bus. It can be learned from FIG. 5 that the UPS is connected to all BMSs by using two transmission lines RS485_A and RS485 B. Each BMS has an RS485 transceiver which is connected to two RS485 buses, to receive and transmit information. It should be noted herein that communication between the UPS and the BMSs is not limited to RS485, and other bus communication such as CAN communication may be performed. RS485 is used as an example for description in these embodiments of the present inventive concept, and other communication modes are similar to RS485 and are not described in detail again. Each external BMS is configured with an input port and an output port for address allocation, and the built-in BMS is configured with only an input port for address allocation. Each BMS further includes one microprocessor control unit (MCU). The MCU is configured to implement control and configuration functions of the BMS, for example, configure the input port and the output port of the BMS. For a person skilled in the art, functions of the MCU of the BMS are known, and details are not described herein. Input ports and output ports, which are configured for addressing, of all the BMSs are serially connected. The UPS system that includes two built-in BMSs and a plurality of external BMSs shown in FIG. 5 includes N-1 external BMSs, a built-in BMS1, and a built-in BMS2 that are serially connected each other. Any external BMS may be used as a first BMS (shown as an external BMS1 in FIG. 5), any one built-in BMS (shown as the built-in BMS 2 in FIG. 5) may be used as a last BMS, and all the BMSs are serially connected through the input ports and output ports in an external-built-in order. As in other embodiments, each BMS is configured with an address allocation flag, which is used to indicate whether the corresponding BMS have completed address allocation. In such a serial connection, an output port of a previous BMS is connected to an input port of a next BMS. In these embodiments of the present inventive concept, the built-in BMS2 is used as the last BMS, and an input port of the built-in BMS1 is connected to an output port of a previous external BMS. Because the built-in BMS has only an input port, an input port of the built-in BMS2 is connected to an output terminal of the UPS. As shown in FIG. 5, the input port of the built-in BMS1 is connected to an output port of an external BMS_N-1, and the input port of the built-in BMS2 is connected to the output terminal of the UPS. The UPS broadcasts an address allocation start instruction. After the address allocation start instruction is sent, the UPS broadcasts address allocation instructions for a plurality of times (the address allocation instruction carries an address to be allocated), and each address allocation instruction carries an address to be allocated, until all the BMSs have completed address allocation. All the BMSs have completed address allocation means that if the UPS continuously broadcasts an address allocation instruction for a preset quantity of times, and does not receive address information replied by any BMS, it is determined that all the BMSs have completed address allocation. Each time the UPS broadcasts an address allocation instruction, a BMS of which an input port is at a first preset level and an address allocation flag is “uncompleted” performs address setting according to the address allocation instruction, and after the address setting is completed, sets the address allocation flag as “completed” and replies address information to the UPS to notify the UPS. The UPS receives the address information replied by a BMS that has completed address allocation, and sends a port configuration instruction to the BMS according to the address information, so that the BMS sets its output port to the first preset level (for example, a low level), while the BMS to which no address is allocated, the BMS to which a different address has been allocated, and a built-in BMS do not respond to the UPS instruction. Each time the UPS broadcasts the address allocation instruction, the BMS whose input port is at the first preset level and whose address allocation flag is set as “uncompleted” performs address setting according to the address allocation instruction, and after the address setting is completed, sets the address allocation flag as “completed” and replies address information to the UPS to notify the UPS. The UPS receives the address information replied by a BMS that completes address allocation, and sends a port configuration instruction to the BMS according to the address information, so that the BMS sets its output port to the first preset level (for example, a low level). The BMS to which no address is allocated, the BMS to which a different address has been allocated, and the built-in BMSs do not respond to the UPS instruction. It should be noted that, when there are two built-in BMSs, an input port of one built-in BMS is not connected to an output port of an external BMS. Because the built-in BMS does not have an output port for address allocation, the output port cannot be set to a low level in response to a port configuration instruction sent by the UPS according to address information. For the built-in BMS2 which is not connected to the external BMS, addressing cannot be completed by setting an output port of a previous BMS. Therefore, when the UPS does not receive replied information for a plurality of continuous times, it can only mean that all external BMSs and a built-in BMS (built-in BMS1 in FIG. 5) whose input port is connected to an output port of one external BMS have completed the address allocation. That is, after all of those BMSs completed the address allocation, the built-in BMS2 still has not completed address allocation. In this case, the output terminal of the UPS is set to the first preset level, and an address allocation instruction is broadcast again to complete the addressing of the built-in BMS2. After completing the addressing, the built-in BMS2 replies address information to the UPS. After receiving the address information replied by the built-in BMS2, the UPS sets the output terminal to a second preset level and broadcasts an address allocation end instruction. After receiving the address allocation end instruction, each BMS sets its output port to a high level.

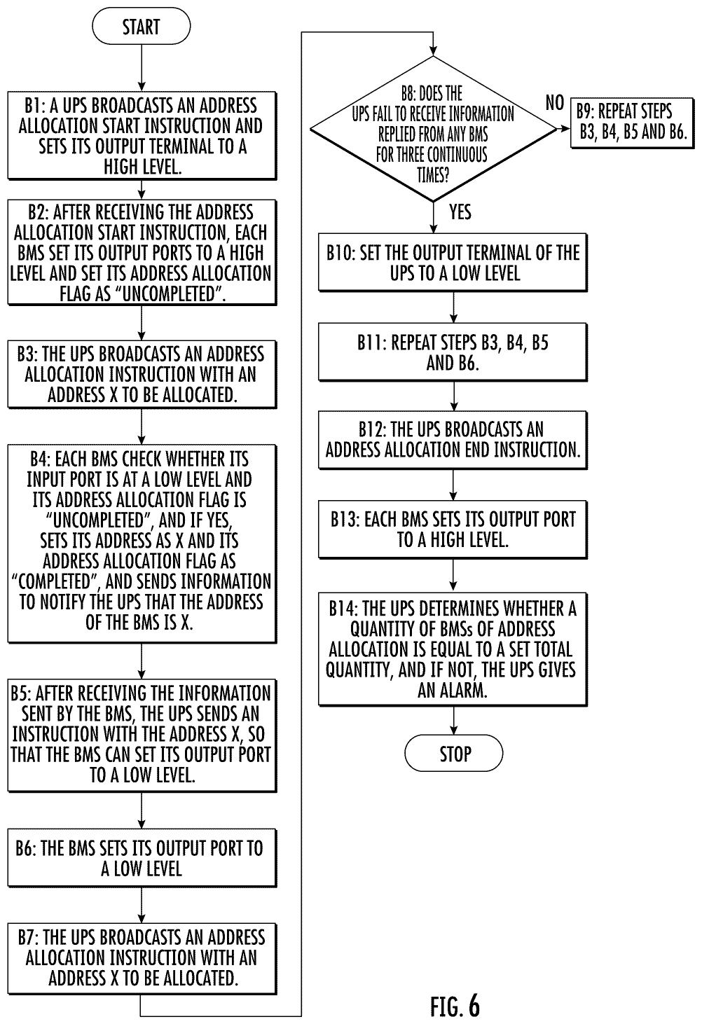

To better understand an addressing process of a UPS system that includes two built-in BMSs in the present inventive concept, the following describes in detail a process of address allocation in a UPS system that includes two built-in BMSs and a plurality of external BMSs with reference to a flowchart shown in FIG. 6, and the process mainly includes the following steps:

Step B1: The UPS broadcasts an address allocation start instruction and sets an output port to a high level.

Step B2: After receiving the address allocation start instruction, each of all BMSs sets its output port to a high level and set its address allocation flag as “uncompleted”.

Step B3: The UPS broadcasts an address allocation instruction, where the address allocation instruction carries an address x to be allocated (x is used to generally indicate a to-be-allocated address, and does not indicate that an address can only be x), that is, after the address allocation start instruction is sent, the UPS broadcasts an address allocation instruction, and the instruction includes an address x to be allocated to a BMS.

Step B4: Each of all the BMSs check whether its input port is at a low level and it address allocation flag is set as “uncompleted”, and if one of the BMSs has the input port at a low level and the address flags as “uncompleted”, the BMS sets its address as the address x, sets its address allocation flags as “completed”, and sends information notify the UPS that the address of the BMS is x. In short, after the UPS broadcasts the address allocation instruction with an address x to be allocated, each BMS receives the instruction and the address x carried in the instruction. The BMS whose input port is at a low level and whose address allocation flag is equal to unallocated sets its address as the address x (the BMS is referred to as BMS_x), sets its address allocation flag as “completed,” and sends an instruction to notify the UPS that the address of the BMS is x. When address allocation is performed for the first time, only the input port of the first BMS is not pulled high and is at a low level. Therefore, only the first BMS has the input port at a low level and the address allocation flag as “uncompleted.” In subsequent allocation, although input ports of a plurality of BMSs may be at a low level, there is only one BMS of which the input port is at a low level and the address allocation flag is uncompleted. Therefore, no address conflict occurs.

Step B5: After receiving the information sent by the BMS_x, the UPS sends a port configuration instruction with the address x to instruct that the BMS_x sets its output port to a low level, while external BMSs with different addresses, the external BMS to which any address is not allocated, and the built-in BMS do not respond.

Step B6: After receiving the port configuration instruction with the address x, the BMS_x sets its output port to a low level. After the address configuration of one BMS is completed, the output port of the BMS is set to a low level, and the input port of a next BMS serially connected to this BMS can be pulled down at the same time, so that the next BMS can participate in the next address configuration.

Step B7: The UPS broadcasts an address allocation instruction with an address x to be allocated.

Step B8: Determine whether the UPS fails to receive information replied by a BMS three continuous times, if yes, step B10 is performed, or if not, step B9 is performed.

Step B9: Repeat the steps B3, B4, B5, and B6.

Step B10: Set an output pin of the UPS to a low level.

Step B11: Repeat the steps B3, B4, B5, and B6.

Step B12: The UPS broadcasts to send an address allocation end instruction.

Step B13: After receiving the address allocation end instruction, each of all the BMSs sets its output port to a high level.

Step B14: The UPS determines whether a quantity of BMSs of address allocation is equal to a set total quantity, and if the quantity of BMSs of address allocation is not equal to the set total quantity, the UPS gives an alarm. As in the foregoing embodiments, herein, the quantity of BMSs of address allocation refers to a quantity of BMSs that have replied address information and completed address allocation. The set total quantity refers to the quantity of BMSs linked to the UPS system before address allocation is performed. A purpose of the comparison is to ensure that all the linked BMSs complete address allocation. If the address allocation is not completed, an alarm is given for remediation.

In addition, it should be noted that a method for address allocation in a UPS system including two or more built-in BMSs is the same as that in a UPS system including only two built-in BMSs. In the UPS system including two or more built-in BMSs, an input port of one built-in BMS is connected to an output port of an external BMS, input ports of the other built-in BMSs are connected to pins of the UPS, and all the BMSs are serially connected. Similar to the case in which there are two built-in BMSs in the foregoing implementation, after addressing of all the external BMSs and a built-in BMS of which an input port is connected to an output port of one external BMS is completed, addressing of the other built-in BMSs is separately completed by using the pins of the UPS, and details are not repeated herein again.

### III. One Built-In BMS and One External BMS

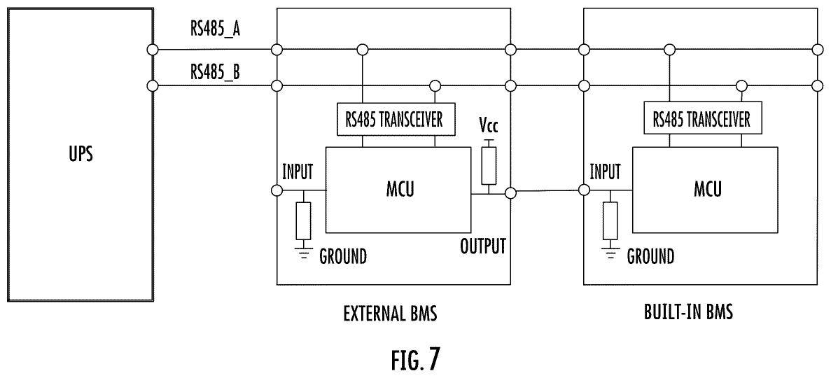

FIG. 7 shows a case in which one built-in BMS and one external BMS are included according to some embodiments of the present inventive concept. A UPS system shown in FIG. 7 includes one UPS, one built-in BMS, and one external BMS. A control logic or a control chip of the UPS communicates with each BMS by using the RS485 bus (because the control logic and the control chip of the UPS are technologies known to a person skilled in the art, the control logic and the control chip are not shown in all the accompanying drawings of the embodiments of the present inventive concept, but this does not affect understanding of the present inventive concept. The accompanying drawings of the embodiments of the present inventive concept highlight the connection and communication between the BMSs and the UPS). It can be learned from FIG. 3 that the UPS is connected to all BMSs by using two transmission lines RS485_A and RS485_B. Each BMS has an RS485 transceiver which is connected to two RS485 buses, to receive and transmit information. It should be noted herein that communication between the UPS and the BMS is not limited to RS485, and other bus communication such as CAN communication may be performed. RS485 is used as an example for description in these embodiments of the present inventive concept, and other communication modes are similar to RS485 and are not described in detail again. The external BMS is configured with an input port and an output port for address allocation, and the built-in BMS is configured with only an input port for address allocation. Each BMS further includes one microprocessor control unit (MCU). The MCU is configured to implement control and configuration functions of the BMS, for example, configure the input port and the output port of the BMS. For a person skilled in the art, functions of the MCU of the BMS are known, and details are not described herein. An output IO of the external BMS is connected to an input IO of the built-in BMS, and an input IO of the external BMS is set to a first preset level. Each BMS is configured with an address allocation flag, which is used to indicate whether the corresponding BMS have completed address allocation.

In the UPS system shown in FIG. 7, when address allocation is performed, an input port of the external BMS is set to the first preset level. The UPS broadcasts an address allocation start instruction. After receiving the address allocation start instruction, the external BMS sets its output port to a second preset level and sets its address allocation flag as “uncompleted,” and the built-in BMS sets its address allocation flag as “uncompleted” according to the address allocation start instruction. The UPS broadcasts an address allocation instruction. The external BMS performs address setting according to the address allocation instruction, and after the address setting is completed, the external BMS sets its address allocation flag as “completed” and replies address information to the UPS. The UPS sends an IO configuration instruction to the external BMS based on the received information replied by the external BMS, so that the external BMS sets its output IO to the first preset level. The UPS broadcasts an address allocation instruction again, and the built-in BMS performs address setting.

It can be learned from the foregoing embodiments that, in the solution of the present inventive concept, address allocation can be implemented by flexibly setting the input port and output port of each BMS, without adding any chip select pin of the UPS, which facilitates flexible modular expansion of the BMS, and is applicable to both a lead-acid battery and a lithium battery.

It should be noted that, although the steps are described above in a specific sequence, it does not mean that the steps need to be performed in the foregoing specific sequence. Actually, some of these steps may be performed concurrently or even change a sequence, provided that a required function can be implemented.

The present inventive concept may be a system, a method, and/or a computer program product. The computer program product may include a computer-readable storage medium that carries computer-readable program instructions for causing a processor to implement various aspects of the present inventive concept.

The computer-readable storage medium may be a tangible device that maintains and stores instructions used by an instruction execution device. The computer-readable storage medium, for example, may include but is not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include a portable computer disk, a hard disk, a random access memory (RAM), a read-only memory (ROM), an erasable programmable read-only memory (EPROM or flash memory), a static random access memory (SRAM), a portable compressed disk read-only memory (CD-ROM), a digital versatile disk (DVD), a memory stick, a floppy disk, a mechanical coding device, for example, a punched card or in-groove convex structure on which instructions are stored, and any suitable combination of the foregoing.

The embodiments of the present inventive concept have been described above. The foregoing description is exemplary and not exhaustive, and is not limited to the disclosed embodiments. Many modifications and changes are apparent to those of ordinary skill in the art without departing from the scope and spirit of the described embodiments. The selection of the terms used in this specification is intended to best explain principles, practical applications, or technical improvements in the market of the embodiments, or to enable others of ordinary skill in the art to understand the embodiments disclosed herein.

What is claimed is:

1. A method for BMS address allocation in a UPS system, wherein the UPS system comprises a UPS, a first built-in BMS, and a plurality of external BMSs, each of the external BMSs being configured with an input port and an output port, and the first built-in BMS being configured with an input port, wherein the plurality of external BMSs are serially connected, an output port of a previous external BMS is connected to an input port of a next external BMS, the input port of the first built-in BMS is connected to an output port of the last external BMS, an input port of a first external BMS is set to a first preset level, and the method comprises:
S1: broadcasting, by the UPS, an address allocation start instruction;
S2: setting, by each of the external BMSs, its output port to a second preset level and its address allocation flag as “uncompleted” according to the address allocation start instruction, and setting, by the first built-in BMS, its address allocation flag as “uncompleted” according to the address allocation start instruction;
S3: broadcasting, by the UPS, an address allocation instruction;
S4: performing, by a BMS whose input port is at the first preset level and whose address allocation flag is “uncompleted”, address setting according to the address allocation instruction, and after the address setting is completed, setting its address allocation flag as “completed” and replying address information to the UPS;
S5: receiving, by the UPS, the address information replied by the BMS that have completed the address setting, and sending a port configuration instruction to the BMS according to the address information, so that the BMS sets its output port to the first preset level; and
S6: repeating steps S3 to S5 until all the BMSs have completed address allocation.

2. The method of claim 1, wherein the first preset level is a low level, the second preset level is a high level, or the first preset level is a high level, and the second preset level is a low level.

3. The method of claim 1, wherein that all the BMSs have completed address allocation specifically is:
if the UPS continuously broadcasts an address allocation instruction for a preset quantity of times, and does not receive the address information replied by any BMS, determining that all the BMSs have completed address allocation.

4. The method of claim 3, wherein the UPS broadcasts an address allocation end instruction after determining that all the BMSs have completed address allocation.

5. The method of claim 1, wherein the UPS system further comprises a second built-in BMS, an input port of the second built-in BMS being connected to an output terminal of the UPS;
the method further comprises:
broadcasting, by the UPS, the address allocation start instruction, and setting the output terminal of the UPS to the second preset level; and
after all the BMSs have completed address allocation, the method further comprises:
setting, by the UPS, the output terminal of the UPS to the first preset level and broadcasting an address allocation instruction; and
performing, by the second built-in BMS, address setting according to the address allocation instruction, and after the address setting is completed, replying, by the second built-in BMS, address information to the UPS.

6. The method of claim 5, further comprising:
after receiving the address information replied by the second built-in BMS, setting, by the UPS, the output terminal of the UPS to the second preset level, and broadcasting, by the UPS, an address allocation end instruction.

7. The method of claim 6, wherein after broadcasting by the UPS, the address allocation end instruction, each of the external BMSs sets its output port to the second preset level according to the address allocation end instruction.

8. The method of claim 4, further comprising:
after broadcasting, by the UPS, the address allocation end instruction, determining, by the UPS, whether a total quantity of the BMSs that have completed the address allocation is equal to a preset total quantity of BMSs, and if the total quantity of the BMSs that have completed the address allocation is not equal to the preset total quantity of BMSs, giving an alarm.

9. A method for BMS address allocation in a UPS system, wherein the UPS system comprises a UPS, one built-in BMS, and one external BMS, the external BMS being configured with an input port and an output port, and the built-in BMS being configured with an input port, wherein the output port of the external BMS is connected to the input port of the built-in BMS, the input port of the external BMS is set to a first preset level, and the method comprises:
broadcasting, by the UPS, an address allocation start instruction;
after receiving the address allocation start instruction, setting, by the external BMS, its output port to a second preset level and its address allocation flag as “uncompleted,” and setting, by the built-in BMS, its address allocation flag to “uncompleted” according to the address allocation start instruction;
broadcasting, by the UPS, an address allocation instruction;
performing, by the external BMS, address setting according to the address allocation instruction, and after the address setting is completed, setting, by the external BMS, its address allocation flag to “completed” and replying address information to the UPS;
sending, by the UPS, a port configuration instruction to the external BMS based on the received information replied by the external BMS, so that the external BMS sets its output port to the first preset level;
broadcasting, by the UPS, an address allocation instruction again; and
performing, by the built-in BMS, address setting.

10. A UPS system, wherein the UPS system comprises a UPS, one built-in BMS, and a plurality of external BMSs, and is configured to perform BMS address allocation by using the method of claim 1.

11. A UPS system comprising a UPS, two built-in BMSs, and a plurality of external BMSs, and is configured to perform BMS address allocation by using the method of claim 5.

12. A UPS system comprising a UPS, one built-in BMS, and one external BMS, and is configured to perform BMS address allocation by using the method of claim 9.
